(19) United States
(12) Patent Application Publication
(10) Pub. No.: US 2026/0319661 A1
(43) Pub. Date: Oct. 15, 2026

(54) MEMORY DEVICE AND METHOD FOR OPTIMIZING READ RETRY TABLE

(71) Applicant: REALTEK SEMICONDUCTOR CORPORATION, HSINCHU (TW)

(72) Inventor: WEN-HONG HUANG, Hsinchu (TW)

(21) Appl. No.: 19/175,011

(22) Filed: Apr. 10, 2025

(30) Foreign Application Priority Data
May 22, 2024 (TW) 113118984

(51) Int. Cl. G06F 3/06; G11C 7/22

(52) U.S. Cl. CPC G06F 3/061; G06F 3/0659; G06F 3/0673

(57) ABSTRACT

A method for optimizing a read retry table includes the following operations: configuring a memory to operate under a predetermined operating condition; utilizing a predetermined read voltage value and an original read retry table to read the memory to generate a test read retry table; and utilizing the test read retry table to read the memory to reorder the test read retry table to generate a reordered read retry table, in which the reordered read retry table is configured to be provided to a memory controller circuit, such that the memory controller circuit reads the memory according to the reordered read retry table.

### BACKGROUND OF THE INVENTION

### 1. Field of the Invention

The present disclosure relates to a memory device, especially to a memory device and a method of optimizing read retry table that are able to improve the operation efficiency of a read retry table.

### 2. Description of Related Art

In some memory applications, when the memory controller cannot utilize a predetermined read voltage value to read the data from the memory, the memory controller will utilize other read voltage values recorded in a read retry table to attempt to read the memory data. In existing applications, the read retry table is typically provided by the memory supplier. However, the order in which the read voltage values are recorded in the read retry table may not necessarily be suitable for the current application scenario. Furthermore, the read voltage values in the read retry table may not adequately cover most error scenarios, causing the memory controller to repeatedly utilize the read retry table multiple times to find an appropriate read voltage value. As a result, the access efficiency of the memory is reduced, thereby lowering the overall system performance.

### SUMMARY OF THE INVENTION

In some aspects, an object of the present disclosure is to, but not limited to, provide a memory device and a method of optimizing read retry table that are able to improve the operation efficiency of a read retry table, so as to make an improvement to the prior art.

In some aspects, a method for optimizing a read retry table includes the following operations: configuring a memory to operate under a predetermined operating condition; utilizing a predetermined read voltage value and an original read retry table to read the memory to generate a test read retry table; and utilizing the test read retry table to read the memory to reorder the test read retry table to generate a reordered read retry table, in which the reordered read retry table is configured to be provided to a memory controller circuit, such that the memory controller circuit reads the memory according to the reordered read retry table.

In some aspects, a memory device includes a storage device and a memory controller circuit. The storage device is configured to store a reordered read retry table. The memory controller circuit is coupled to the storage device, and is configured to read a memory according to a predetermined read voltage value, and read the memory according to the reordered read retry table if the memory is not successfully read based on the predetermined read voltage value, in which the reordered read retry table is generated by reordering a test read retry table, and the test read retry table is generated by reading the memory using the predetermined read voltage value and an original read retry table of the memory when the memory is configured to operate under a predetermined operating condition.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a memory device according to some embodiments of the present disclosure.

FIG. 2 illustrates a flowchart of a method for optimizing a read retry table according to some embodiments of the present disclosure.

FIG. 3 illustrates a flowchart of steps corresponding to an operation in FIG. 2 according to some embodiments of the present disclosure.

FIG. 4 illustrates a flowchart of steps of an operation in FIG. 2 according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

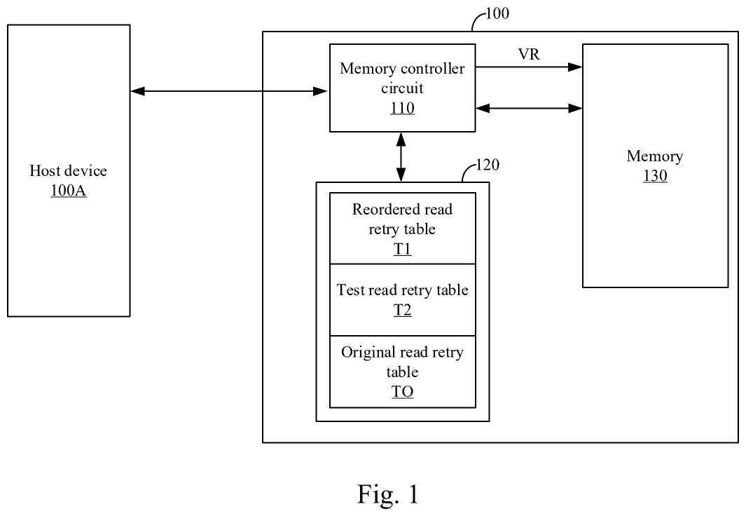

FIG. 1 illustrates a schematic diagram of a memory device 100 according to some embodiments of the present disclosure. The memory device 100 is coupled to a host device 100A. The host device 100A may issue a read command and/or a write command. In response to the read command, the memory device 100 may provide data requested by the host device 100A to the host device 100A. In response to the write command, the host device 100A may store the data to be saved in the memory device 100.

The memory device 100 includes a memory controller circuit 110, a storage device 120, and a memory 130. The memory controller circuit 110 accesses the memory 130 according to the aforementioned read command and/or write command to read data from the memory 130 and/or store data into the memory 130. In some embodiments, the memory controller circuit 110 may be implemented with a microprocessor circuit or microcontroller circuit with computational capabilities, but the present disclosure is not limited thereto. In some embodiments, the memory controller circuit 110 may utilize a read voltage VR having a predetermined read voltage value to read data from the memory 130. In some embodiments, the storage device 120 may be, but is not limited to, a register, and may be integrated into the memory controller circuit 110. In some embodiments, the storage device 120 and the memory 130 may be, but are not limited to, non-volatile memory. In some embodiments, the memory 130 may be, but is not limited to, a flash memory. If the read voltage VR having the predetermined read voltage value is sufficient to turn on a memory cell in the memory 130, the memory controller circuit 110 may determine that the data in the memory cell is a bit “1.” Alternatively, if the read voltage VR having the predetermined read voltage value is insufficient to turn on the memory cell in the memory 130, the memory controller circuit 110 may determine that the data in the memory cell is a bit “0.”

In some embodiments, after reading data from the memory 130, the memory controller circuit 110 may perform an error correcting code (ECC) algorithm based on the data to determine whether the readback data contains error(s), thereby determining whether the page of the memory 130 storing the data is able to be successfully read using the read voltage VR having the predetermined read voltage value. If the readback data includes uncorrectable error(s), the memory controller circuit 110 may determine that the page storing the data was not successfully read using the read voltage VR having predetermined read voltage value. Alternatively, if the readback data contains correctable error(s) or no error, the memory controller circuit 110 may determine that the page storing the data was successfully read using the read voltage VR having the predetermined read voltage value. In some embodiments, the aforementioned ECC algorithm may include, but is not limited to, a low-density parity-check (LDPC) code algorithm.

In some embodiments, the storage device 120 is configured to store a reordered read retry table T1. The reordered read retry table T1 indicates information regarding read voltage values. As described above, if the readback data includes uncorrectable error(s), it indicates that the page in the memory 130 storing the data was not successfully read using the read voltage VR having the predetermined read voltage value. Under this condition, the memory controller circuit 110 may utilize the read voltage values in the reordered read retry table T1 to read the page in a predetermined sequence. For example, the memory controller circuit 110 may read the reordered read retry table T1 in the predetermined sequence to obtain a first read voltage value in the reordered read retry table T1. As a result, the memory controller circuit 110 may use the read voltage VR having the first read voltage value to read the page again. If the page is not successfully read using the read voltage VR having the first read voltage value, the memory controller circuit 110 obtains a second read voltage value in the reordered read retry table T1 according to the predetermined sequence and uses the read voltage VR having the second read voltage value to read the page again. By this analogy, the memory controller circuit 110 may utilize the read voltage values in the reordered read retry table T1 to read the memory 130, thereby obtaining the correct data from the memory 130. In some embodiments, the configuration of the reordered read retry table T1 will be described in subsequent paragraphs (e.g., as shown in Table 2 below).

In some embodiments, the storage device 120 may also store an original read retry table TO and a test read retry table T2. In some embodiments, the original read retry table TO may be a read retry table provided by a supplier or a manufacturer of the memory 130. In some embodiments, the original read retry table TO includes information provided by the supplier or the manufacturer regarding read voltage values for reading the memory 130. In some embodiments, the read voltage values in the original read retry table TO may be divided into multiple sets, each corresponding to different application scenarios. For example, the read voltage values may be divided into sets, with each set corresponding to different operating temperatures and/or different usage durations. In some embodiments, the reordered read retry table T1 is generated by reordering the test read retry table T2, which is generated by using the aforementioned predetermined read voltage value and the original read retry table TO to read the memory 130. Compared with the original read retry table TO, the read voltage values in the reordered read retry table T1 may have broader error coverage, and read voltage values with higher read success rates are assigned higher usage priority, thereby improving the efficiency of reading the memory 130 and enhancing overall system performance. In some embodiments, the storage device 120 may store reordered read retry tables T1, each corresponding to the aforementioned different application scenarios. In some embodiments, the storage device 120 may store only the reordered read retry table T1. In some embodiments, the storage device 120 may store only the reordered read retry table T1 and the original read retry table TO.

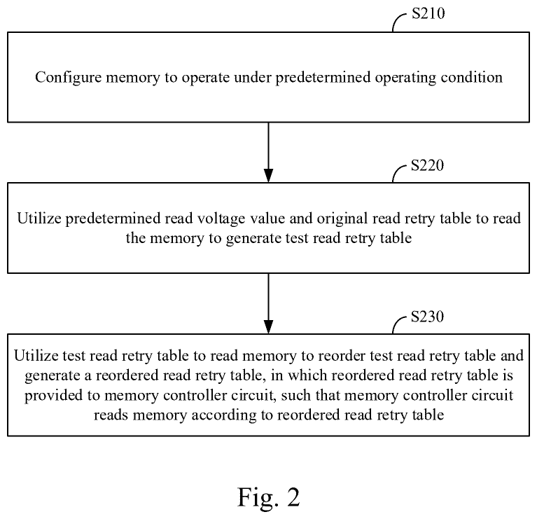

In different embodiments, the reordered read retry table T1 may be generated either online or offline. In some embodiments, if the reordered read retry table T1 is generated online, the memory controller circuit 110 (or the software/firmware of the host device 100A) may perform operations described in FIG. 2 to generate the reordered read retry table T1. In other embodiments, if the reordered read retry table T1 is generated offline, the operations described in FIG. 2 may be performed during the manufacturing (or design phase) of the memory device 100 by utilizing computer-aided systems for integrated circuit design and/or related testing tools in conjunction with the memory controller circuit 110, in order to utilize the original read retry table TO to generate the reordered read retry table T1 in advance and store the reordered read retry table T1 in the storage device 120.

FIG. 2 illustrates a flowchart of a method 200 for optimizing a read retry table according to some embodiments of the present disclosure. In operation S210, a memory is configured to operate under a predetermined operating condition. In some embodiments, the operating temperature of the memory 130 may be adjusted to a temperature specified for a particular application scenario by using burn-in software and/or burn-in tools, and all pages of the memory 130 are written with known predetermined data.

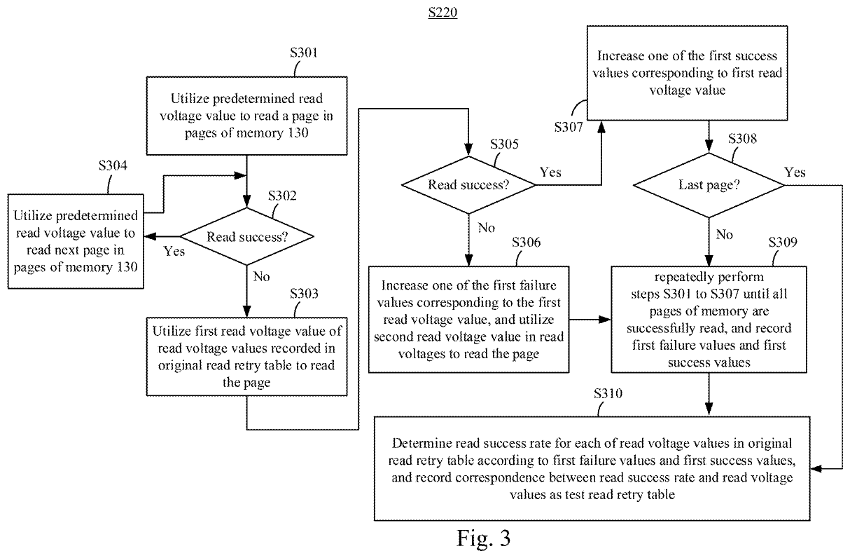

In operation S220, a predetermined read voltage value and an original read retry table are utilized to read the memory to generate a test read retry table (e.g., the test read retry table T2). For example, the memory controller circuit 110 may utilized the read voltage VR having the predetermined read voltage value to read the memory 130 in response to a read command from the host device 100A (which at this stage may be, but is not limited to, a test system). If the read operation is unsuccessful, the memory controller circuit 110 may use other read voltage values from the original read retry table TO to read the memory 130, thereby generating the test read retry table T2. Embodiments of operation S220 will be described below with reference to FIG. 3.

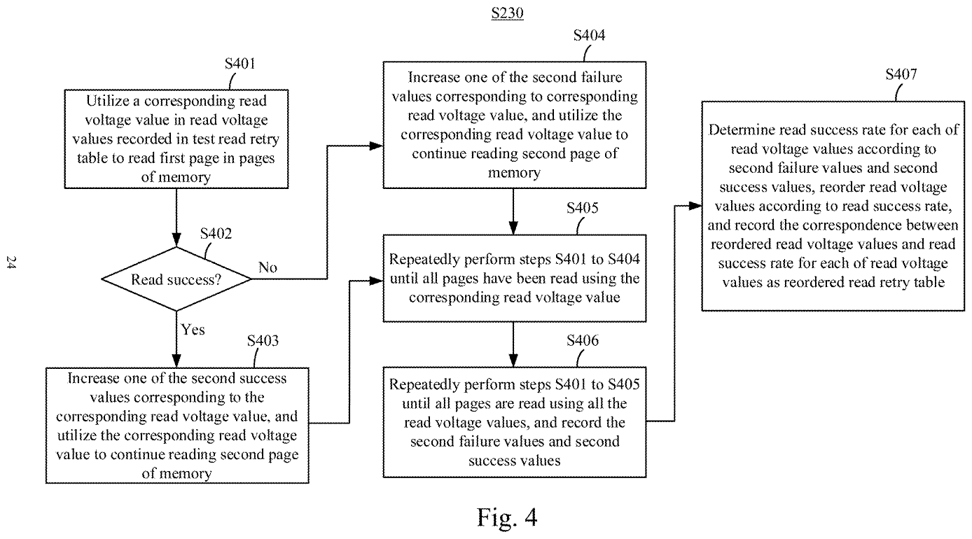

In operation S230, the test read retry table is utilized to read the memory to reorder the test read retry table and a reordered read retry table (e.g., the aforementioned reordered read retry table T1) is generated, in which the reordered read retry table is provided to a memory controller circuit, such that the memory controller circuit reads the memory according to the reordered read retry table. For example, the memory controller circuit 110 may utilize read voltage values in the test read retry table T2 to generate the read voltage VR having a corresponding read voltage value to read the memory 130 in response to a read command from the host device 100A (which at this stage may be, but is not limited to, a test system). The memory controller circuit 110 may then reorder these read voltage values according to read success rates corresponding to the read voltage values to generate the reordered read retry table T1, and store the same in the storage device 120. As a result, the memory controller circuit 110 may read the memory 130 according to the reordered read retry table T1 stored in the storage device 120. Embodiments of operation S230 will be described later with reference to FIG. 4.

FIG. 3 illustrates a flowchart of steps corresponding to operation S220 in FIG. 2 according to some embodiments of the present disclosure. In some embodiments, operation S220 in FIG. 2 includes steps S301 to S310. In step S301, the predetermined read voltage value is utilized to read a page in pages of the memory 130. In step S302, whether the page is successfully read based on the predetermined read voltage value is determined. If the page is not successfully read based on the predetermined read voltage value, step S303 is performed. Alternatively, if the page is successfully read based on the predetermined read voltage value, step S304 is performed. For example, the memory controller circuit 110 may generate the read voltage VR having the predetermined read voltage value to read a first page of the memory 130 and perform the aforementioned ECC algorithm to determine whether the first page is able to be successfully read using the predetermined read voltage value. If the data read back from the first page includes uncorrectable error(s), which is checked by the ECC algorithm, it is determined that the first page is not successfully read using the predetermined read voltage value. Alternatively, if the data read back from the first page includes correctable error(s) or no errors, which is checked by the ECC algorithm, it is determined that the first page is successfully read using the predetermined read voltage value.

In step S303, a first read voltage value of read voltage values recorded in the original read retry table is utilized to read the page. In step S304, the predetermined read voltage value is utilized to read a next page in the pages of the memory 130. In step S305, whether the page is successfully read based on the first read voltage value is determined. If the page is not successfully read based on the first read voltage value, step S306 is performed. If the page is successfully read based on the first read voltage value, step S307 is performed.

For example, the memory controller circuit 110 may generate the read voltage VR having the first read voltage value according to the read voltage values in the original read retry table TO, and read the first page of the memory 130 according to this read voltage VR. Subsequently, the memory controller circuit 110 may determine whether the first page is successfully read based on the first read voltage value by the ECC algorithm. In some embodiments, the read voltage values utilized in step S303 may include all the read voltage values in the original read retry table TO. In some embodiments, the read voltage values used in step S303 may correspond to the read voltage values in the original read retry table TO that match the predetermined operating conditions in operation S210 of FIG. 2.

In step S306, one of the first failure values corresponding to the first read voltage value is increased, and a second read voltage in the read voltages is utilized to read the page. For example, after determining that the first page is not successfully read using the first read voltage value, the memory controller circuit 110 may increase the first failure value corresponding to the first read voltage value by 1 to record the number of pages that cannot be read using the first read voltage value. Subsequently, the memory controller circuit 110 may generate the read voltage VR having the second read voltage value according to the second read voltage value in the original read retry table TO, and read the page of the memory 130 according to this read voltage VR.

In step S307, one of the first success values corresponding to the first read voltage value is increased. For example, after determining that the first page is successfully read using the first read voltage value, the memory controller circuit 110 may increase the first success value corresponding to the first read voltage value by 1 to record the number of pages that can be successfully read using the first read voltage value. In step S308, whether the currently read page is the last page of the memory 130 is determined. If the currently read page is not the last page of the memory 130, step S309 is performed to continue reading the next page of the memory 130. Alternatively, if the currently read page is the last page of the memory 130, step S310 is performed.

In step S309, steps S301 to S307 are repeatedly performed until all pages of the memory are successfully read, and the first failure values and the first success values are recorded. In step S310, the read success rate for each of the read voltage values in the original read retry table is determined according to the first failure values and the first success values, and the correspondence between the read success rate and the read voltage values is recorded as the test read retry table.

With the above steps, the first failure values and first success values corresponding to the read voltage values in the original read retry table TO are recorded during the process of reading all pages of the memory 130, thereby determining the read success rates corresponding to the read voltage values. As a result, the test read retry table T2 can be generated according to the read success rates. In some embodiments, the test read retry table T2 generated in step S308 is as shown in Table 1 below.

TABLE 1

| read retry entry | read success rate |
|---|---|
| first read voltage value | 50% |
| second read voltage value | 1% |
| third read voltage value | 40% |
| fourth read voltage value | 0.5% |
| fifth read voltage value | 4% |
| . | . |
| . | . |
| . | . |

In some embodiments, the sum of the read success rates of the read voltage values recorded in the test read retry table T2 may be 100%. In some embodiments, the sum of the read success rates of the read voltage values recorded in the test read retry table T2 may be close to 100%, and the total of all read success rates and the error rate tolerable by the ECC algorithm may equal 100%, but the present disclosure is not limited thereto. In some embodiments, the predetermined operating conditions in operation S210 of FIG. 2 may be replaced (equivalent to replacing the application scenario of the memory 130), and steps of FIG. 3 may be repeatedly performed to obtain additional first failure values and first success values, thereby determining the read success rates in Table 1 above.

In some embodiments, the original read retry table TO records the read voltage values in a predetermined sequence, and the memory controller circuit 110 utilizes the read voltage values according to this predetermined sequence. With the steps described in FIG. 3, the memory controller circuit 110 may determine a primary voltage value in the read voltage values that successfully reads a corresponding page of the memory 130 (i.e., a first successful voltage value identified in sequence). For example, in the predetermined sequence, the read voltage values in the original read retry table TO are arranged sequentially as the first read voltage value, the second read voltage value, the third read voltage value, . . . , and the Nth read voltage value. If it is determined that the first page of the memory 130 is not successfully read using the predetermined read voltage value, the memory controller circuit 110 may utilize the first read voltage value in the predetermined sequence to read the first page. If it is determined that the first page of the memory 130 is still not successfully read using the first read voltage value, the memory controller circuit 110 may utilize the second read voltage value in the predetermined sequence to read the first page. With this analogy, the memory controller circuit 110 may utilize the read voltage values in the predetermined sequence to read the first page until the first page is successfully read. If the first page is successfully read using the second read voltage value, the second read voltage value is the primary voltage value in the read voltage values that successfully reads the first page.

FIG. 4 illustrates a flowchart of steps of operation S230 in FIG. 2 according to some embodiments of the present disclosure. In some embodiments, operation S230 in FIG. 2 includes steps S401-S407. In step S401, the corresponding read voltage value in the read voltage values recorded in the test read retry table is utilized to read the first page in the pages of the memory. In step S402, whether the first page is successfully read based on the corresponding read voltage value is determined. If it is determined that the first page is successfully read using the corresponding read voltage value, step S403 is performed. If it is determined that the first page is not successfully read using the corresponding read voltage value, step S404 is performed.

For example, the memory controller circuit 110 may generate the read voltage VR having the first read voltage value according to Table 1 (i.e., the test read retry table T2) to read the first page of the memory 130 and determine, by the ECC algorithm, whether the first page is successfully read using the first read voltage value.

In step S403, one of the second success values corresponding to the corresponding read voltage value is increased, and the corresponding read voltage value is utilized to continue reading a second page of the memory. In step S404, one of the second failure values corresponding to the corresponding read voltage value is increased, and the corresponding read voltage value is utilized to continue reading the second page of the memory. In step S405, step S401 to step S404 are repeatedly performed until all pages have been read using the corresponding read voltage value.

For example, after determining that the first page is not successfully read using the first read voltage value, the memory controller circuit 110 may increase the second failure value corresponding to the first read voltage value by 1 to record the number of pages that cannot be read using the first read voltage value. Alternatively, after determining that the first page is successfully read using the first read voltage value, the memory controller circuit 110 may increase the second success value corresponding to the first read voltage value by 1 to record the number of pages that can be successfully read using the first read voltage value. Subsequently, the memory controller circuit 110 may continue using the first read voltage value to read the next page of the memory 130, thereby continuing to adjust the second failure value and the second success value corresponding to the first read voltage value until all pages have been read.

In step S406, step S401 to step S405 are repeatedly performed until all the pages are read using all the read voltage values, and the second failure values and second success values are recorded. For example, after completing the adjustment of the second failure value and second success value corresponding to the first read voltage value, the memory controller circuit 110 may generate the read voltage VR having the second read voltage value according to the aforementioned Table 1 to read the first page of the memory 130 and determine, by the ECC algorithm, whether the second page is successfully read using the second read voltage value. As a result, after reading all pages of the memory 130 using the second read voltage value, the adjustment of the second failure value and second success value corresponding to the second read voltage value can be completed. Similarly, the memory controller circuit 110 may utilize all the read voltage values in the test read retry table T2 to read all pages of the memory 130, thereby adjusting and recording the second failure values and second success values.

In step S407, the read success rate for each of the read voltage values is determined according to the second failure values and second success values, the read voltage values are reordered according to the read success rates, and the correspondence between the reordered read voltage values and the read success rate for each of the read voltages is recorded as the reordered read retry table.

With the above steps, the second failure values and second success values corresponding to the read voltage values in the test read retry table T2 are recorded during the process of reading all pages of the memory 130, thereby determining the read success rates corresponding to the read voltage values when actually reading the pages. As a result, the test read retry table T2 can be reordered according to the read success rates to generate the reordered read retry table T1. In some embodiments, the reordered read retry table T1 generated in step S406 is as shown in Table 2 below.

TABLE 2

| read retry entry | read success rate |
|---|---|
| fifth read voltage value | 99% |
| third read voltage value | 90% |
| first read voltage value | 83% |
| second read voltage value | 73% |
| fourth read voltage value | 22% |
| . | . |
| . | . |
| . | . |

In some embodiments, the read voltage values in the reordered read retry table T1 are recorded in a sequence, where a primary voltage value in the read voltage values (e.g., the fifth read voltage value in Table 2) has the highest read success rate for the memory 130. With this configuration, the memory controller circuit 110 may utilize the read voltage values in the sequence recorded in the reordered read retry table T1, allowing the memory controller circuit 110 to prioritize the use of the fifth read voltage value with the highest read success rate to read the memory 130. As a result, the number of retries can be reduced, improving the efficiency of accessing the memory 130 and thereby enhancing the overall system performance.

The above operations can be understood with reference to the above embodiments, and thus the repetitious descriptions are not further given. Operations in FIG. 2 to FIG. 4 include exemplary operations, but the operations in FIG. 2 to FIG. 4 are not necessarily performed in the order described above, the operations in FIG. 2 to FIG. 4 may be added, replaced, changed order, and/or eliminated, or one or more operations in FIG. 2 to FIG. 4 may be executed simultaneously or partially simultaneously as appropriate, in accordance with the spirit and scope of various embodiments of the present disclosure.

As described above, the memory device and the method for optimizing a read retry table provided in some embodiments of the present disclosure may find read voltage values in the original read retry table provided by the memory supplier that can cover most application scenarios, and reorder these read voltage values to improve the access efficiency of the memory device, thereby enhancing overall system performance.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

1. A method for optimizing a read retry table, comprising:
configuring a memory to operate under a predetermined operating condition;
utilizing a predetermined read voltage value and an original read retry table to read the memory to generate a test read retry table; and
utilizing each of a plurality of read voltage values in the test read retry table to sequentially read a plurality of pages of the memory to determine a first read success rate for each of the plurality of read voltage values, in order to reorder the test read retry table according to the first read success rate to generate a reordered read retry table,
wherein the first read success rate is determined based on a result of reading the plurality of pages, and the reordered read retry table is configured to be provided to a memory controller circuit, such that the memory controller circuit reads the memory according to the reordered read retry table.

2. The method for optimizing a read retry table of claim 1, wherein the original read retry table is configured to record the plurality of read voltage values in a predetermined sequence, and utilizing the predetermined read voltage value and the original read retry table to read the memory to generate the test read retry table comprises:
utilizing the predetermined read voltage value to read a page in the memory; and
if the page is not successfully read based on the predetermined read voltage value, utilizing the plurality of read voltage values in the predetermined sequence to read the page and determining a primary voltage value in the plurality of read voltage values that successfully reads the page to generate the test read retry table.

3. The method for optimizing a read retry table of claim 1, wherein the original read retry table is configured to record the plurality of read voltage values, and utilizing the predetermined read voltage value and the original read retry table to read the memory to generate the test read retry table comprises:
step 1: utilizing the predetermined read voltage value to read a first page in the plurality of pages of the memory;
step 2: if the first page is not successfully read based on the predetermined read voltage value, utilizing a first read voltage value in the plurality of read voltage values to read the first page;
step 3: if the first page is not successfully read based on the first read voltage value, increasing one of a plurality of failure values corresponding to the first read voltage value and utilizing a second read voltage value of the plurality of read voltage values to read the first page;
step 4: if the first page is successfully read based on the first read voltage value, increasing one of a plurality of success values corresponding to the first read voltage value;
step 5: repeatedly performing the step 1 to the step 4 until each of the plurality of pages is successfully read, and recording the plurality of failure values and the plurality of success values; and
step 6: determining a second read success rate for each of the plurality of read voltage values in the original read retry table according to the plurality of failure values and the plurality of success values, and recording a correspondence between the second read success rate and the plurality of read voltage values as the test read retry table.

4. The method for optimizing a read retry table of claim 1, wherein utilizing each of the plurality of read voltage values in the test read retry table to sequentially read the plurality of pages of the memory to determine the first read success rate for each of the plurality of read voltage values, in order to reorder the test read retry table according to the first read success rate to generate the reordered read retry table comprises:
step 1: utilizing a first read voltage value in the plurality of read voltage values recorded in the test read retry table to read a first page in the plurality of pages of the memory;
step 2: if the first page is successfully read based on the first read voltage value, increasing one of a plurality of success values corresponding to the first read voltage value and continuing to utilize the first read voltage value to read a second page of the plurality of pages;
step 3: if the first page is not successfully read based on the first read voltage value, increasing one of a plurality of failure values corresponding to the first read voltage value and continuing to utilize the first read voltage value to read the second page;
step 4: repeatedly performing the step 1 to the step 3 until all the plurality of pages have been read utilizing the first read voltage value;
step 5: repeatedly performing the step 1 to the step 4 until all the plurality of pages have been read utilizing all the plurality of read voltage values, and recording the plurality of failure values and the plurality of success values; and
step 6: determining the first read success rate for each of the plurality of read voltage values according to the plurality of failure values and the plurality of success values, reordering the plurality of read voltage values in the test read retry table according to the first read success rate, and recording a correspondence between the reordered plurality of read voltage values and the first read success rate for each of the plurality of read voltage values as the reordered read retry table.

5. The method for optimizing a read retry table of claim 1, wherein the reordered read retry table is configured to record the plurality of read voltage values in a first sequence, and a primary voltage value in the plurality of read voltage values has a highest read success rate for the memory.

6. The method for optimizing a read retry table of claim 5, wherein the memory controller circuit is configured to utilize the plurality of read voltage values in the first sequence to read the memory.

7. A memory device, comprising:
a storage device configured to store a reordered read retry table; and
a memory controller circuit coupled to the storage device, the memory controller circuit configured to read a memory according to a predetermined read voltage value, and read the memory according to the reordered read retry table if the memory is not successfully read based on the predetermined read voltage value,
wherein the reordered read retry table is generated by utilizing each of a plurality of read voltage values recorded in a test read retry table to sequentially read a plurality of pages of the memory to determine a first read success rate for each of the plurality of read voltage values, and reordering the test read retry table according to the first read success rate, the first read success rate is determined based on a result of reading the plurality of pages, and the test read retry table is generated by reading the memory using the predetermined read voltage value and an original read retry table of the memory when the memory is configured to operate under a predetermined operating condition.

8. The memory device of claim 7, wherein the reordered read retry table is configured to record the plurality of read voltage values in a first sequence, and a primary voltage value in the plurality of read voltage values has a highest read success rate for the memory.

9. The memory device of claim 8, wherein the memory controller circuit is configured to utilize the plurality of read voltage values in the first sequence to read the memory.

10. The memory device of claim 7, wherein the reordered read retry table is generated by determining a primary voltage value in the plurality of read voltage values in the original read retry table that successfully reads a page of the memory when the page is not successfully read based on the predetermined read voltage value.

11. The memory device of claim 7, wherein the test read retry table is generated by a plurality of steps, and the plurality of steps comprise:
step 1: utilizing the predetermined read voltage value to read a first page in the plurality of pages of the memory;
step 2: if the first page is not successfully read based on the predetermined read voltage value, utilizing a first read voltage value in a plurality of read voltage values to read the first page;
step 3: if the first page is not successfully read based on the first read voltage value, increasing one of a plurality of failure values corresponding to the first read voltage value and utilizing a second read voltage value of the plurality of read voltage values to read the first page;
step 4: if the first page is successfully read based on the first read voltage value, increasing one of a plurality of success values corresponding to the first read voltage value;
step 5: repeating the step 1 to the step 4 until each of the plurality of pages is successfully read, and recording the plurality of failure values and the plurality of success values; and
step 6: determining a second read success rate for each of the plurality of read voltage values in the original read retry table according to the plurality of failure values and the plurality of success values, and recording a correspondence between the second read success rate and the plurality of read voltage values as the test read retry table.

12. The memory device of claim 7, wherein the reordered read retry table is generated by a plurality of steps, and the plurality of steps comprise:
step 1: utilizing a first read voltage value in the plurality of read voltage values recorded in the test read retry table to read a first page in the plurality of pages of the memory;
step 2: if the first page is successfully read based on the first read voltage value, increasing one of a plurality of success values corresponding to the read voltage value and continuing to utilize the read voltage value to read a second page of the plurality of pages;
step 3: if the first page is not successfully read based on the first read voltage value, increasing one of a plurality of failure values corresponding to the first read voltage value and continuing to utilize the first read voltage value to read the second page;
step 4: repeating the step 1 to the step 3 until all the plurality of pages have been read utilizing the first read voltage value;
step 5: repeating the step 1 to the step 4 until all the plurality of pages have been read utilizing all the plurality of read voltage values, and recording the plurality of failure values and the plurality of success values; and
step 6: determining the first read success rate for each of the plurality of read voltage values according to the plurality of failure values and the plurality of success values, reordering the plurality of read voltage values according to the first read success rate, and recording a correspondence between the reordered plurality of read voltage values and the first read success rate for each of the plurality of read voltage values as the reordered read retry table.

13. A method for optimizing a read retry table, comprising:
configuring a memory to operate under a predetermined operating condition;
utilizing a predetermined read voltage value and an original read retry table to read the memory to generate a test read retry table; and
utilizing the test read retry table to read the memory to reorder the test read retry table to generate a reordered read retry table,
wherein the reordered read retry table is configured to be provided to a memory controller circuit, such that the memory controller circuit reads the memory according to the reordered read retry table,
wherein the original read retry table is configured to record a plurality of read voltage values, and utilizing the predetermined read voltage value and the original read retry table to read the memory to generate the test read retry table comprises:
step 1: utilizing the predetermined read voltage value to read a first page in a plurality of pages of the memory;
step 2: if the first page is not successfully read based on the predetermined read voltage value, utilizing a first read voltage value in the plurality of read voltage values to read the first page;
step 3: if the first page is not successfully read based on the first read voltage value, increasing one of a plurality of failure values corresponding to the first read voltage value and utilizing a second read voltage value of the plurality of read voltage values to read the first page;
step 4: if the first page is successfully read based on the first read voltage value, increasing one of a plurality of success values corresponding to the first read voltage value;
step 5: repeatedly performing the step 1 to the step 4 until each of the plurality of pages is successfully read, and recording the plurality of failure values and the plurality of success values; and
step 6: determining a read success rate for each of the plurality of read voltage values according to the plurality of failure values and the plurality of success values, and recording a correspondence between the read success rate and the plurality of read voltage values as the test read retry table.

14. The method for optimizing a read retry table of claim 13, wherein the original read retry table is configured to record a plurality of read voltage values in a predetermined sequence, and utilizing the predetermined read voltage value and the original read retry table to read the memory to generate the test read retry table comprises:
utilizing the predetermined read voltage value to read a page in the memory; and
if the page is not successfully read based on the predetermined read voltage value, utilizing the plurality of read voltage values in the predetermined sequence to read the page and determining a primary voltage value in the plurality of read voltage values that successfully reads the page to generate the test read retry table.

15. The method for optimizing a read retry table of claim 13, wherein the reordered read retry table is configured to record a plurality of read voltage values in a first sequence, and a primary voltage value in the plurality of read voltage values has a highest read success rate for the memory.

16. The method for optimizing a read retry table of claim 15, wherein the memory controller circuit is configured to utilize the plurality of read voltage values in the first sequence to read the memory.
